(19) United States
(12) Patent Application Publication
(10) Pub. No.: US 2012/0024826 A1
(43) Pub. Date: Feb. 2, 2012

(54) METHOD FOR WELDING TWO COMPONENTS

(75) Inventors: Joachim Bamberg, Dachau (DE); Alexander Gindorf, Schwabhausen (DE); Guenter Zenzinger, Petershausen (DE); Ulrich Retze, Taufkirchen (DE)

(73) Assignee: MTU Areo Engines GmbH, Munich (DE)

(21) Appl. No.: 13/263,063

(22) PCT Filed: Mar. 25, 2010
(86) PCT No.: PCT/DE2010/000328

§ 371 Date: Oct. 5, 2011

(30) Foreign Application Priority Data
Apr. 7, 2009 (DE) 102009016799.4

(51) Int. Cl. B23K 11/00

(52) U.S. Cl. 219/117.1

(57) ABSTRACT

A method for welding two components is disclosed. In an embodiment, the method includes the following process steps. The two components are positioned such that the joining surfaces are opposite each other, at a short distance from each other. A high-frequency electrical current is conducted through the two components, heating the components at least in the region of the joining surfaces. The two components are pressed against each other such that the two joining surfaces are welded together.

### BACKGROUND AND SUMMARY OF THE INVENTION

This application claims the priority of International Application No. PCT/DE2010/000328, filed Mar. 25, 2010, and German Patent Document No. 10 2009 016 799.4, filed Apr. 7, 2009, the disclosures of which are expressly incorporated by reference herein.

The invention relates to a method for welding two components.

A high-frequency induction welding process for connecting blade parts of a gas turbine is known from German Patent Document No. DE 198 58 702 B4. The blade parts have joining surfaces which are welded to one another by electromagnetic induction using an inductor and by moving them together with contact of the joining surfaces, thereby forming a weld joint. The inductor is a separate tool component, which is arranged around the joining surfaces of the blade parts. As a result, it is necessary for the process that there is adequate free space available for the inductor adjacent to the components, in particular for a movement when positioning the inductor on the weld joint. The disadvantage of this solution is that the heat input to the components does not take place in a defined manner.

The object of the invention is creating a method for welding two components with a defined heat input to the joining zones that has minimum requirements for the free space surrounding the components to be welded.

The object of the invention is attained by a method according to the invention for welding two components with joining surfaces to be connected, which comprises the following process steps. The two components are positioned such that the joining surfaces are opposite each other, at a short distance from each other. A high-frequency electrical current is conducted through the two components, heating the components at least in the region of the joining surfaces. The two components are pressed against each other such that the two joining surfaces are welded together. Using a high-frequency electrical current produces a high current density in the region of the surface of the two components, because of the skin effect. Due to the small distance between the joining surfaces of the two components, the current density in the region of the joining surfaces is increased again because of the proximity effect. Because of the especially high current density in the region of the joining surfaces of the components, the components heat up essentially locally in the region of the joining surfaces. In this way, a separate inductor is not required in the region of the joining surfaces. Only a minimum amount of free space is required around the two components to be able to introduce the high-frequency electrical current to the components.

According to a preferred variant of the method, the distance between the joining surfaces is less than or equal to 1 mm, preferably less than or equal to 0.5 mm. Because of the small distance between the joining surfaces, the proximity effect is intensified.

The high-frequency electrical current may be conducted via a conductor element into the components, wherein the conductor element is fabricated of a material with high electrical conductivity, in particular copper. This makes a good introduction of the electrical current to the components possible with low electric resistance in the conductor element and therefore low heating of the conductor element.

In the case of a preferred exemplary embodiment of the invention, the conductor element is designed to be flat, in particular in the form of a conductive mat. In this way, the conductivity of the conductor element for high-frequency electrical current is improved on the one hand, and on the other hand, the surface in which the electrical current is conducted into the components is increased, thereby preventing a selective welding of the conductor element with the components.

The components preferably have a lower electrical conductivity than the conductor element. This ensures that the components essentially heat up, while heating of the conductor element remains as low as possible.

The components are advantageously fabricated of materials with low electrical conductivity, in particular titanium or nickel. In this way, almost 100% of the electrical power introduced to the joining surfaces is converted into heat.

The high-frequency electrical current is preferably introduced to the components in the region of the joining surfaces. As a result, the heating of other regions of the components is reduced.

According to a preferred variant of the method, the two components are connected in series in a circuit for introducing the high-frequency electrical current. This makes a simple arrangement of the circuit possible, wherein only one current source is required.

According to a preferred variant of the method, the method for welding a blade on a rotor base body is used for producing an integrally bladed rotor, in particular of a gas turbine. In this case, it is particularly advantageous that the method may also be used to weld materials for which the fusion welding process may not be used, for example monocrystalline materials.

According to a further variant of the method, the method for welding a blade or a blade segment onto a rotor base body is used for repairing an integrally bladed rotor, in particular of a gas turbine. In the case of repairing an integrally bladed rotor, normally only one or only a few blades of the rotor have to be replaced. As a result, it is particularly advantageous that only a minimum amount of free space is required adjacent to the joining surfaces of the components to be connected.

Additional features and advantages of the invention are disclosed in the following description and in the following drawings, to which reference is made.

### BRIEF DESCRIPTION OF THE DRAWINGS

FIG. 1 illustrates a first step of a method according to the invention, in which the components are positioned relative to one another;

FIG. 2 illustrates a second step of a method according to the invention, in which a high-frequency electrical current is conducted into the components; and

FIG. 3 illustrates a third step of a method according to the invention, in which the components are pressed against each other.

### DETAILED DESCRIPTION OF THE DRAWINGS

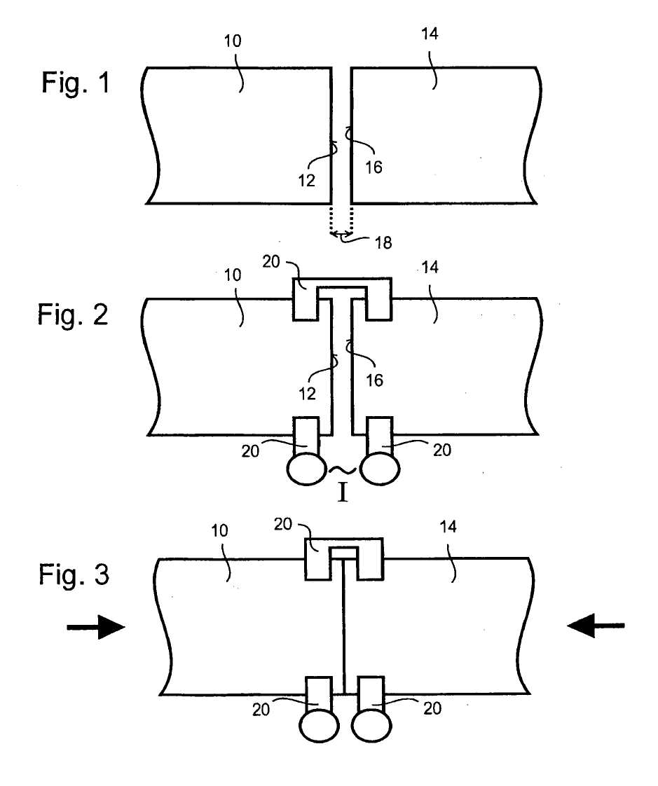

FIG. 1 depicts a first component 10 with a first joining surface 12 and a second component 14 with a second joining surface 16. The two components 10, 14 are positioned in such a way that the joining surfaces 12, 16 are opposite each other, at a short distance 18 from each other. The distance 18 is 1 mm or less, and preferably 0.5 mm or less.

In a process step depicted in FIG. 2, conductor elements 20 are attached in the region of the joining surfaces 12, 16, wherein the two components 10, 14 are connected in series in a circuit. The conductor elements 20 are made of copper mats having a high electrical conductivity, in particular for high-frequency electrical currents.

A high-frequency electrical current I is introduced to the two components 10, 14 via the conductor elements 20. Because of the skin effect and the proximity effect, the current density concentrates essentially in the joining surfaces 12, 16 of the components 10, 14. The skin effect and the proximity effect are based on an electromagnetic induction into the two components 10, 14 by the high-frequency electrical current I. The high-frequency current I preferably has a frequency in the range of 0.75 MHz to 1.2 MHz.

The components 10, 14 are fabricated of titanium or nickel and have a lower electrical conductivity than the conductor elements 20. As a result, approximately 100% of the electrical power introduced to the joining surfaces is converted into heat.

If the components 10, 14 in the region of the joining surfaces 12, 16 have reached the desired temperature, the two components 10, 14 are pressed against each other so that the two joining surfaces 12, 16 are welded together. This step is depicted in FIG. 3. In this case, it is possible that the two components 10, 14 are moved against one another or that only one component 10 is moved, while the other component 14 is kept stationary.

The time progression of the method, in particular the duration of introducing the high-frequency electrical current I, may be determined empirically, using a measurement of the temperature on the joining surfaces 12, 16, or a measurement of the change in the electrical conductivity of the components 10, 14 may be controlled as a function of the temperature.

The method is especially suited for producing integrally bladed rotors, in particular for gas turbines, in which a separately produced blade or a separately produced blade part is welded onto a rotor base body. In doing so, little free space is available between the adjacent blades, particularly in the case of rotors having a high number of blades, so that conventional induction welding processes with a separate inductor or friction welding methods cannot be used. In particular, only a small amount of free space is present between the blade parts of the adjacent blades in the radial inner region of the blade where the weld area is located.

It is particularly advantageous for integrally bladed rotors of gas turbines that materials for which the fusion welding process may not be used, such as monocrystalline materials, may also be welded with the method.

The method also makes it possible to repair an integrally bladed rotor by removing a damaged blade and welding on a new blade. In this case, integrally bladed rotors that were produced using another production method, for example by milling, electro-chemical machining or other welding methods, may also be repaired.

1-10. (canceled)

11. A method for welding two components, comprising the steps of:
positioning a joining surface of a first component a short distance from a joining surface of a second component and opposite from the joining surface of the second component;
conducting a high-frequency electrical current through the first and second components, thus heating the components at least in a region of the respective joining surfaces; and
pressing the first and second components against each other such that the respective joining surfaces are welded together.

12. The method according to claim 11, wherein the distance is less than or equal to 1 mm.

13. The method according to claim 11, wherein the distance is less than or equal to 0.5 mm.

14. The method according to claim 11, wherein the high-frequency electrical current is conducted via a conductor element into the first and second components, wherein the conductor element is comprised of a material having high electrical conductivity.

15. The method according to claim 14, wherein the material is copper.

16. The method according to claim 14, wherein the conductor element is flat.

17. The method according to claim 16, wherein the conductor element is a conductive mat.

18. The method according to claim 14, wherein the first and second components have a lower electrical conductivity than the high electrical conductivity of the conductor element.

19. The method according to claim 11, wherein the first and second components are comprised of a material with low electrical conductivity.

20. The method according to claim 19, wherein the material is titanium or nickel.

21. The method according to claim 11, further comprising the step of introducing the high-frequency electrical current into the first and second components in the region of the respective joining surfaces.

22. The method according to claim 11, further comprising the step of connecting the first and second components in series in a circuit.

23. The method according to claim 11, wherein the first component is a blade and the second component is a rotor base body.

24. The method according to claim 23, wherein the blade and the rotor base body are components of a gas turbine.
